(19) United States
(12) Patent Application Publication
(10) Pub. No.: US 2011/0223813 A1
(43) Pub. Date: Sep. 15, 2011

(54) COMMUNICATION CONNECTOR

(75) Inventor: Shern-Yun Shian, Taipei City (TW)

(73) Assignee: PRIMECON TECHNOLOGY LTD., Taipei (TW)

(21) Appl. No.: 13/038,431

(22) Filed: Mar. 2, 2011

(30) Foreign Application Priority Data
Mar. 12, 2010 (TW) 099204462

(51) Int. Cl. H01R 13/40

(52) U.S. Cl. 439/733.1

(57) ABSTRACT

A communication connector includes a base enclosure defining a receiving space, the receiving space having two opposite ends and a bottom respectively defined as a first, a second and a third opening, which are communicable with one another, and the first opening being provided along a periphery thereof with a retaining section; a connection terminal held in the base enclosure with two ends extending to the second and the third opening of the receiving space; and a cover plate closing the first opening of the receiving space and being provided along a periphery with an engaging section for correspondingly engaging with the retaining section at the first opening. With these arrangements, the cover plate can be quickly and firmly assembled to the first opening of the receiving space to enclose the connection terminal in the base enclosure, and the communication connector can be mass-produced to ensure increased good yield thereof.

### CROSS-REFERENCE TO RELATED APPLICATION

This non-provisional application claims priority under 35 U.S.C. §119(a) on Patent Application No(s). 099204462 filed in Taiwan, R.O.C. on Mar. 12, 2010, the entire contents of which are hereby incorporated by reference.

### FIELD OF THE INVENTION

The present invention relates to a communication connector, and more particularly to a communication connector that can be easily processed and assembled and can be mass-produced to ensure increased good yield thereof.

### BACKGROUND OF THE INVENTION

Generally, a conventional communication connector 4 as that shown in FIGS. 1, 2 and 3 includes a base enclosure 41 having one side provided with an opening 42, a connection terminal 43 held in the base enclosure 41, and a rear plug 44 tightly fitted in the opening 42. The communication connector 4 can be mounted to a desired circuit board (not shown) to thereby connect to a desired electronic connector for signal transmission.

Since the communication connector 4 has a very small volume, the rear plug 44 and other components therefore all have a relatively small volume, too. With the small volume, the rear plug 44 and other components must be manually assembled to the base enclosure 41 using suitable tools to thereby increase the assembling cost of the communication connector 4. Further, as a matter of fact, the rear plug 44 is so small in volume that it does not provide sufficient area for holding it by hands. This prevents the use of a tool to assemble the rear plug 44 to the opening 42 easily. As a result, the assembling of the conventional communication connector 4 is difficult and the bad yield thereof is high. Moreover, the rear plug 44 is assembled to the opening 42 simply by tight-fitting without being provided with any other structure to ensure secured connection of the plug 44 to the base enclosure 41. Thus, the rear plug 44 tends to separate from the opening 42 during the use of the communication connector 4 or due to thermal expansion when the temperature in the working environment of the communication connector changes.

It is therefore desirable to develop an improved communication connector that can be easily processed and assembled and can be mass-produced to ensure increased good yield thereof.

### SUMMARY OF THE INVENTION

A primary object of the present invention is to provide a communication connector that includes a base enclosure and a cover plate being so designed that the cover plate can be quickly and firmly assembled to the base enclosure to enclose a connection terminal in the base enclosure, so that the communication connector can be easily processed and assembled and can be mass-produced to ensure increased good yield thereof.

To achieve the above and other objects, the communication connector according to the present invention includes a base enclosure internally defining a receiving space, the receiving space having two opposite ends and a bottom respectively defined as a first, a second and a third opening, which are communicable with one another, and the first opening being provided along a periphery thereof with a retaining section; a connection terminal held in the receiving space of the base enclosure with two ends separately extending to the second and the third opening of the receiving space; and a cover plate closing the first opening of the receiving space and being provided along a periphery with an engaging section for correspondingly engaging with the retaining section at the first opening.

With the above arrangements for the communication connector of the present invention, the cover plate can be quickly and firmly assembled to the base enclosure to enclose the connection terminal in the receiving space, and the communication connector can be mass-produced to ensure increased good yield thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional communication connector;

FIG. 2 is an assembled view of FIG. 1;

FIG. 3 is a sectional view taken along line A-A′ of FIG. 2;

FIG. 4 is an exploded perspective view of a communication connector according to a first embodiment of the present invention;

FIG. 5 is an assembled view of FIG. 4;

FIG. 6 is a sectional view taken along line B-B′ of FIG. 5;

FIG. 7 is an exploded perspective view of a communication connector according to a second embodiment of the present invention;

FIG. 8 is an assembled view of FIG. 7;

FIG. 9 is a sectional view taken along line C-C′ of FIG. 8; and

FIG. 10 is a bottom view of FIG. 8.

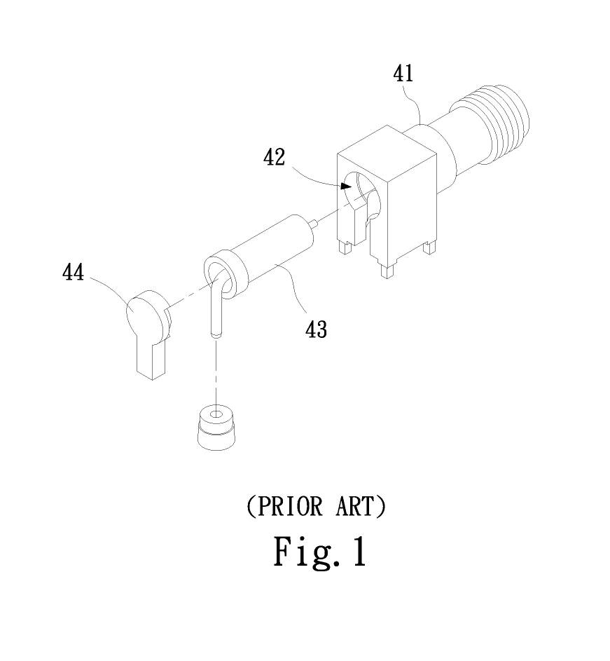

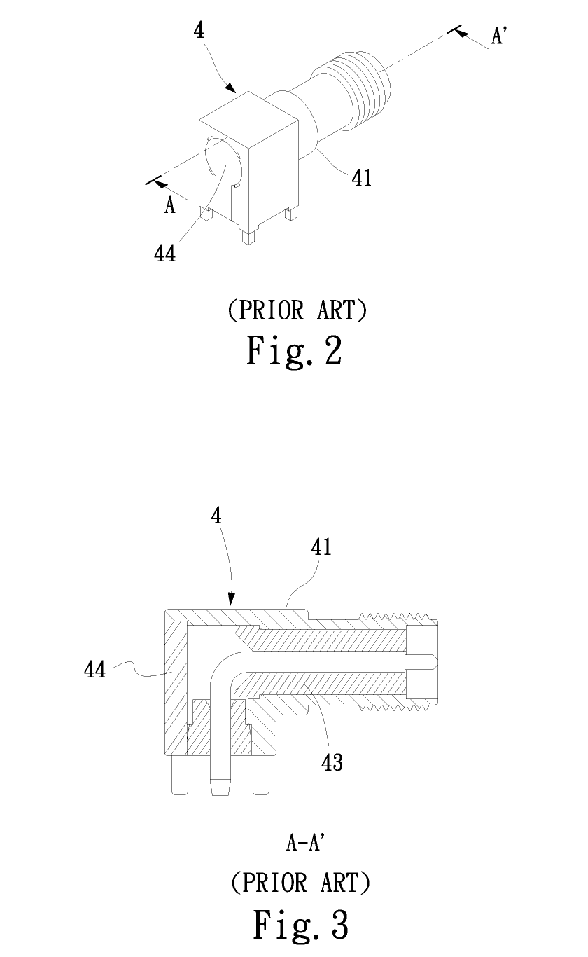

### DETAILED DESCRIPTION OF THE PREFERRED EMBODIMENTS

The present invention will now be described with some preferred embodiments thereof and with reference to the accompanying drawings.

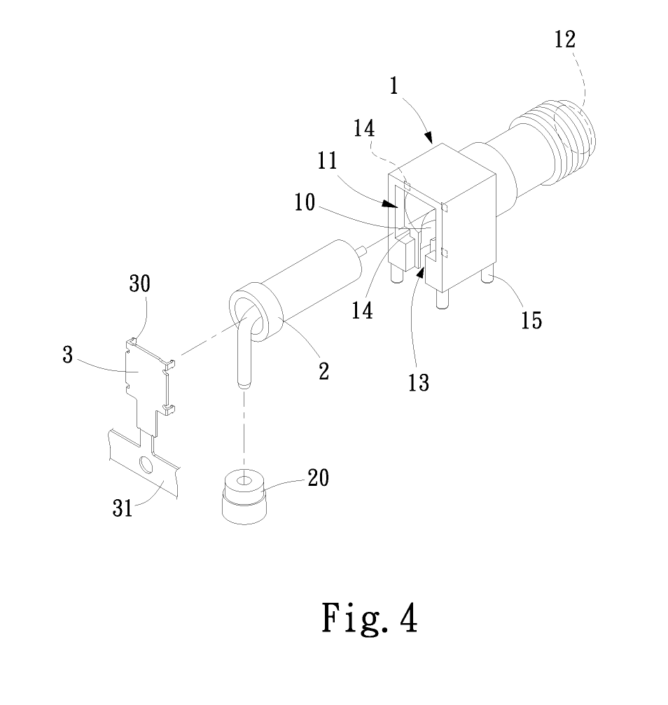

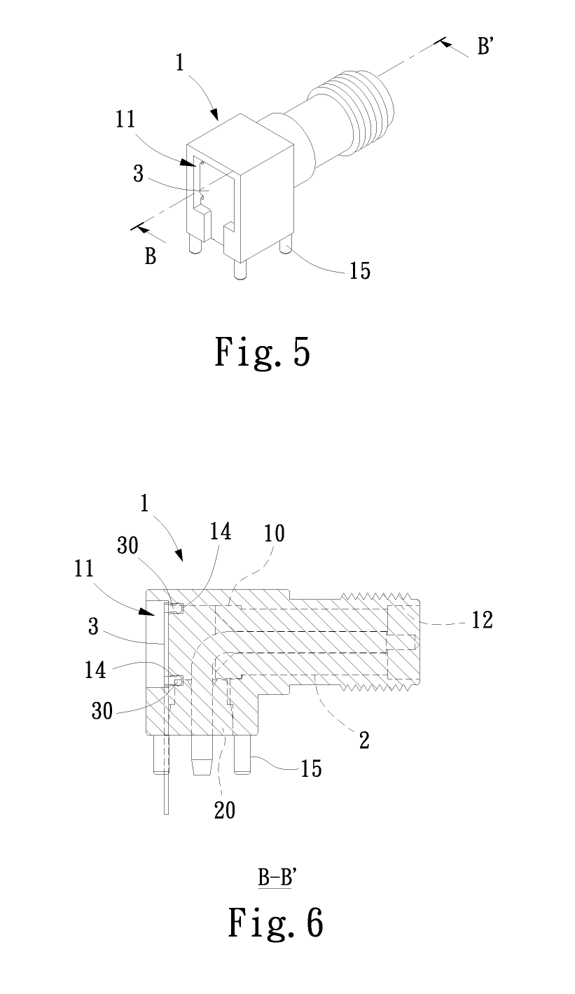

Please refer to FIGS. 4 and 5 that are exploded and assembled perspective views, respectively, of a communication connector according to a first embodiment of the present invention, and to FIG. 6 that is a sectional view taken along line B-B′ of FIG. 5. As shown, the communication connector in the first embodiment includes at least a base enclosure 1, a connection terminal 2, and a cover plate 3.

The base enclosure 1 internally defines a receiving space 10, which has two opposite ends respectively defined as a first opening 11 and a second opening 12 as well as a bottom defined as a third opening 13. The first, the second and the third opening 11, 12, 13 are communicable with one another. The first opening 11 is provided along a periphery thereof with a retaining section 14, which may include a plurality of locating holes; and the base enclosure 1 is provided at a bottom thereof with a plurality of fixing posts 15.

The connection terminal 2 is held in the receiving space 10 with two opposite ends of the connection terminal 2 separately extending to the second opening 12 and the third opening 13. A locating member 20 is provided on one end of the connection terminal 2 to locate in the receiving space 10 at a position corresponding to the third opening 13.

The cover plate 3 serves to close the first opening 11 of the receiving space 10, and is provided along a periphery with an engaging section 30 for correspondingly engaging with the retaining section 14 at the first opening 11. The engaging section 30 may include a plurality of insertion pins for correspondingly engaging with the locating holes of the retaining section 14. The cover plate 3 can be formed on a material strip 31 by way of stamping.

To assemble the communication connector, first extend one end of the connection terminal 2 through the first opening 11 of the base enclosure 1, so that the connection terminal 2 is received in the receiving space 10 with two opposite ends of the connection terminal 2 separately extending to the second and the third opening 12, 13 of the receiving space 10; and then connect the locating member 20 to the end of the connection terminal 2 that is located at the third opening 13, so as to complete the assembling of the connection terminal 2 to the base enclosure 1 and form a subassembly thereof. Thereafter, assemble the cover plate 3 to the base enclosure 1. This assembling step can be performed on an automated machine (not shown) by placing the material strip 31 with a plurality of cover plates 3 continuously formed and arranged thereon as well as a plurality of the subassemblies of the base enclosure 1 and the connection terminal 2 on the automated machine. With the automated machine, the cover plates 3 on the material strip 31 can be correspondingly connected to the first openings 11 of the receiving spaces 10 defined in the base enclosures 1 with the engaging sections 30 correspondingly engaged with the retaining sections 14. In this manner, the cover plate 3 can be quickly and firmly assembled to the first opening 11 of the receiving space 10 to enclose the connection terminal 2 in the base enclosure 1. With the above arrangements, the communication connector of the present invention is easy to process and assemble and can be mass-produced to ensure increased good yield thereof.

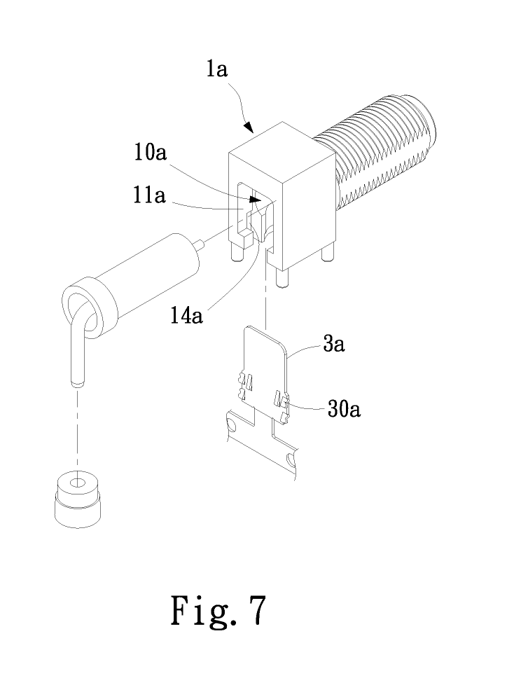

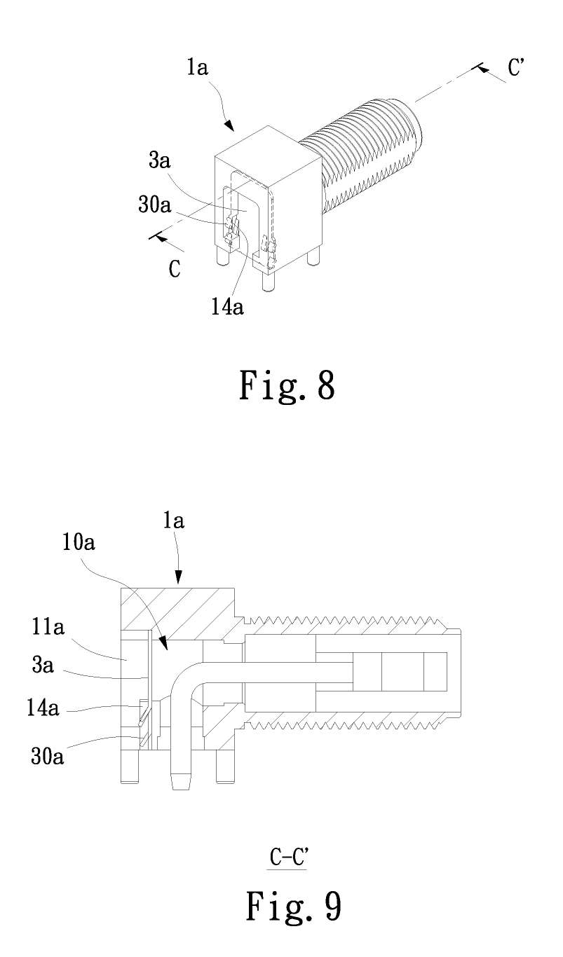

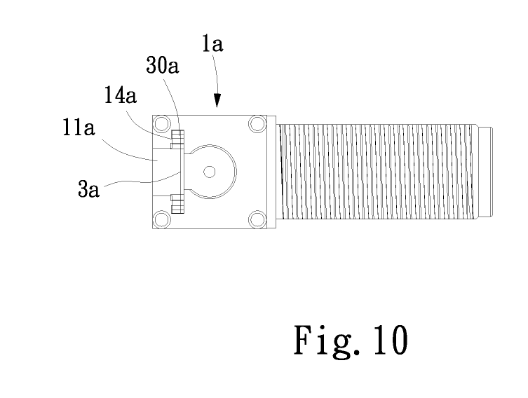

FIGS. 7 and 8 are exploded and assembled perspective views, respectively, of a communication connector according to a second embodiment of the present invention; FIG. 9 is a sectional view taken along line C-C′ of FIG. 8; and FIG. 10 is a bottom view of FIG. 8. As shown, in addition to the first embodiment, the communication connector of the present invention can also be implemented as the second embodiment. The communication connector in the second embodiment is generally structurally similar to the first embodiment but includes a base enclosure 1a and a cover plate 3a. The base enclosure 1a internally defines a receiving space 10a having a first opening 11a, along a periphery of which a retaining section 14a in the form of a rabbet is provided. And, the cover plate 3a is provided with an engaging section 30a that may include a plurality of barbs for correspondingly pressing against the rabbet. With these arrangements, the cover plate 3a can also be quickly and firmly assembled to the base enclosure 1a to achieve the same effect as that provided by the first embodiment.

With the above arrangements, the communication connector according to the present invention is novel, improved and industrially valuable. The present invention is novel and improved because the base enclosure and the cover plate are so designed that the cover plate can be quickly and firmly assembled to the first opening of the receiving space to enclose the connection terminal in the base enclosure, allowing the communication connector to be easily processed and assembled and be mass-produced to ensure increased good yield thereof. And, the present invention is industrially valuable because products derived there from would no doubt satisfy the current market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A communication connector, comprising:
a base enclosure internally defining a receiving space; the receiving space having two opposite ends and a bottom respectively defined as a first opening, a second opening and a third opening, which are communicable with one another; and the first opening being provided along a periphery thereof with a retaining section;
a connection terminal being held in the receiving space of the base enclosure with two ends of the connection terminal separately extending to the second and the third opening of the receiving space; and
a cover plate closing the first opening of the receiving space and being provided along a periphery with an engaging section for correspondingly engaging with the retaining section at the first opening.

2. The communication connector as claimed in claim 1, wherein the base enclosure is provided at a bottom thereof with a plurality of fixing posts.

3. The communication connector as claimed in claim 1, wherein the retaining section provided along the periphery of the first opening includes a plurality of locating holes, and the engaging section provided on the cover plate includes a plurality of insertion pins for correspondingly engaging with the locating holes of the retaining section.

4. The communication connector as claimed in claim 1, wherein the retaining section provided along the periphery of the first opening is in the form of a rabbet, and the engaging section provided on the cover plate includes a plurality of barbs for pressing against the rabbet.

5. The communication connector as claimed in claim 1, further comprising a locating member provided on one end of the connection terminal to locate in the receiving space corresponding to the third opening.

6. The communication connector as claimed in claim 1, wherein the cover plate is formed on a material strip by way of stamping.
